(19) United States
(12) Patent Application Publication
(10) Pub. No.: US 2020/0032562 A1
(43) Pub. Date: Jan. 30, 2020

(54) LOCK ASSEMBLY

(71) Applicant: ASSA ABLOY NEW ZEALAND LIMITED, North Shore City (NZ)

(72) Inventor: Stuart HORWOOD, Auckland (NZ)

(21) Appl. No.: 16/521,843

(22) Filed: Jul. 25, 2019

(30) Foreign Application Priority Data
Jul. 30, 2018 (NZ) 744728

(51) Int. Cl. E05C 9/04; E05B 9/04; E05B 9/08

(52) U.S. Cl. CPC E05C 9/047; E05B 9/084; E05B 9/04

(57) ABSTRACT

A lock assembly comprising: a cradle configured to support at least part of a lock cylinder; a lock body configured to retain the cradle at least partly inside a space provided in the lock body; and a first fastener for fastening the lock cylinder to the cradle. A method for installing a lock assembly in a door or window comprising: attaching a lock cylinder to a cradle using a first fastener; and attaching the cradle to a lock body. A lock assembly comprising: a lock body having a longitudinal axis; a first bolt provided at least in part inside the lock body and configured to move substantially parallel to the longitudinal axis and between a first retracted position and a first extended position; an actuator configured to move the first bolt between the first retracted position and the first extended position; and a locking bar configured in an unlocked position to allow the first bolt to move to or from the first extended position and in a locked position to engage with the first bolt preventing the first bolt from moving from the first extended position.

### CROSS-REFERENCE TO RELATED APPLICATION

This application claims the benefit of New Zealand Patent Application No. 744728 filed Jul. 30, 2018, the entire disclosure of which is incorporated herein by reference in its entirety.

### FIELD

This invention relates to a lock assembly. More particularly, this invention relates to a lock assembly for a window or door and a method for installing the same.

### BACKGROUND

Lock assemblies for windows and doors come in an increasing variety of configurations. The configuration of lock assembly will depend on, among other factors, the type of window or door (for example, French or sliding), the type of frame (for example, extruded aluminium or wood) and the type of security needed (for example, a latch bolt or a dead bolt). While lock assemblies may be relatively bespoke to their application, some parts of the lock assembly may be a standard design. It can be beneficial to use standard parts within a lock assembly as it can decrease the cost of manufacture, improve interoperability between locking systems and make replacing parts more straightforward.

An example of a part that is commonly available with a standard design is the lock cylinder. The lock cylinder typically includes the keyhole and, when installed, interacts with the rest of the lock assembly to enable locking and unlocking. Lock cylinders are available in a few standard designs, with the Euro style lock cylinder being one of the most commonly available. A problem associated with such lock cylinders is that their means of being fastened to the rest of a lock assembly is a screw hole provided in the side of the lock cylinder. Thus, in order for a lock assembly to be compatible with the lock cylinder, the rest of the lock assembly (i.e. the ‘lock body’) must also include a corresponding screw hole. Having such holes on the sides of the lock cylinder means that to enable installation of the lock assembly in an extruded frame, it is necessary to form an opening in the side of the extruded frame so that a fastener can be inserted through the holes of the lock body and lock cylinder. Such an opening may be undesirable from a structural, waterproofing and/or aesthetic point of view. It can also mean that the lock body is ‘handed’ depending on which face of the lock body the keyhole of the lock cylinder needs to be. This may mean having different lock bodies depending on whether the door or window is to be opened on the right or left-hand side.

One configuration of a lock assembly is a vertical bolt lock. In a vertical bolt lock, the lock assembly includes one or more bolts that can be moved in a vertical direction between an extended position and a retracted position. The bolt may be attached to a rod, which extends above or below the locking assembly to engage with a strike plate mounted in the frame of the window or door to lock the window or door. This type of lock assembly is particularly suited to French doors/windows and some bi-fold doors/windows as the lock stile of the locking panel of such doors/windows may not meet the frame. A problem associated with some vertical bolt locks is that the bolt is kept in a locked position by suitably locking the drive mechanism. Thus, if the drive mechanism is compromised (for example, by applying sufficient force to the handle, severing the connection between the drive mechanism and the bolt), the lock assembly may be unlocked.

### SUMMARY

According to one example embodiment there is provided a lock assembly comprising: a cradle configured to support at least part of a lock cylinder; a lock body configured to retain the cradle at least partly inside a space provided in the lock body; and a first fastener for fastening the lock cylinder to the cradle.

The cradle may comprise a first cradle hole adapted to receive the first fastener. The first cradle hole may be substantially perpendicular to a cylindrical axis of the lock cylinder when installed. The first cradle hole may be positioned so that when the cradle supports at least part of the lock cylinder, the first cradle hole aligns with a lock cylinder hole provided in the lock cylinder such that the first fastener can pass through both the first cradle hole and the lock cylinder hole to fasten the lock cylinder to the cradle.

The cradle may be configured to be retained inside the space. The cradle may comprise a second cradle hole configured to receive a second fastener, the second fastener for fastening the cradle to the lock body. The lock body may comprise a lock body hole configured to receive the second fastener. The second cradle hole may be substantially parallel to a cylindrical axis of the lock cylinder when installed.

The lock body may be configured to retain the cradle inside the space.

The lock cylinder may be a Euro style lock cylinder.

The first fastener may be one of a first screw, a first pin or a first rivet. The first fastener may not visible when the lock assembly is installed.

According to another example embodiment there is provided a cradle configured for the lock assembly of any one of the above paragraphs.

According to a further example embodiment there is provided a lock assembly kit comprising the lock assembly of any one of the above paragraphs and a lock cylinder configured for the lock assembly.

According to yet another example embodiment, there is provided a method for installing a lock assembly in a door or window comprising: attaching a lock cylinder to a cradle using a first fastener; and attaching the cradle to a lock body.

Attaching the lock cylinder to the cradle may precede attaching the cradle to the lock body.

Attaching the cradle to the lock body may comprise attaching the cradle to the lock body using a second fastener.

The method may comprise inserting at least part of the cradle into a space provide inside the lock body. The method may further comprise: forming an opening in an extruded member of the window or door, the opening located to correspond to an intended location of the space; and inserting the lock body inside the extruded member such that the space meets the opening. The method may further comprise inserting the cradle in the space through the opening.

The method may be for the lock assembly of any one of the above paragraphs.

According to a yet further example embodiment, there is provided a lock assembly comprising: a lock body having a longitudinal axis; a first bolt provided at least in part inside the lock body and configured to move substantially parallel to the longitudinal axis and between a first retracted position and a first extended position; an actuator configured to move the first bolt between the first retracted position and the first extended position; and a locking bar configured in an unlocked position to allow the first bolt to move to or from the first extended position and in a locked position to engage with the first bolt preventing the first bolt from moving from the first extended position.

The locking bar may comprise a cam follower housing, the cam follower housing comprising a cam follower that has a surface which engages with an end of a cam provided in a lock cylinder such that rotation of the cam causes the cam follower and the locking bar to move.

The first bolt may be configured to be connected to a first rod, the first rod extending away from the lock body such that a first rod distal end of the first rod is able to engage with a first strike plate provided in a frame of a window or door. The first rod may extend either above the lock body or below the lock body.

The first bolt may comprise a first rack coupled to a corresponding first set of teeth provided on the actuator.

The lock assembly may comprise a second bolt provided at least in part inside the lock body and configured to move substantially parallel to the longitudinal axis and between a second retracted position and a second extended position, wherein: the actuator is configured to move the second bolt between the second retracted position and the second extended position; and the locking bar is configured in the unlocked position to allow the first bolt to move to or from the first extended position or the second bolt to move to or from the second extended position.

The locking bar may be configured in a locked position to engage with the second bolt preventing the second bolt from moving from the second extended position.

The first bolt and second bolt may move in opposite directions. The actuator may be configured to move both the first bolt and second bolt simultaneously.

The locking bar may be configured so that it can only move from the unlocked position to the locked position provided the first bolt is in the first extended position and/or the second bolt is in the second extended position.

The second bolt may be configured to be connected to a second rod, the second rod extending away from the lock body such that a second rod distal end of the second rod is able to engage with a second strike plate provided in a frame. The second rod may extend to the opposite side of the lock body than a first rod.

The second bolt may comprise a second rack coupled to a corresponding second set of teeth provided on the actuator.

The lock assembly may be configured for use in a window or a door, being one of a French or bi-fold type.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1a is a perspective view of a front side of a locking panel including a lock assembly in a latched position according to one example embodiment;

FIG. 1b is a perspective view of a front side of the locking panel of FIG. 1a in an unlatched position;

FIG. 2a is an exploded perspective view of part of a lock assembly including a lock cylinder according to one example embodiment;

FIGS. 2b-2e are perspective views of the lock assembly of FIG. 2a at various stages of installation;

FIG. 3a is a perspective view of part of a lock assembly according to an example embodiment in a latched position and an unlocked position;

FIG. 3b is a perspective view of the lock assembly of FIG. 3a in an unlatched position and an unlocked position;

FIG. 3c is a perspective view of the lock assembly of FIG. 3a in a latched position and a locked position;

FIG. 4a is a perspective view of part of a lock assembly with the front casing removed according to an example embodiment in an unlocked position;

FIGS. 4b-4g are perspective views of the lock assembly of FIG. 4a at various stages between being in an unlocked position and a locked position; and

FIGS. 5a-5c are perspective view of variants of the lock assembly of Figure.

### DETAILED DESCRIPTION

### Locking Panel Including Lock Assembly

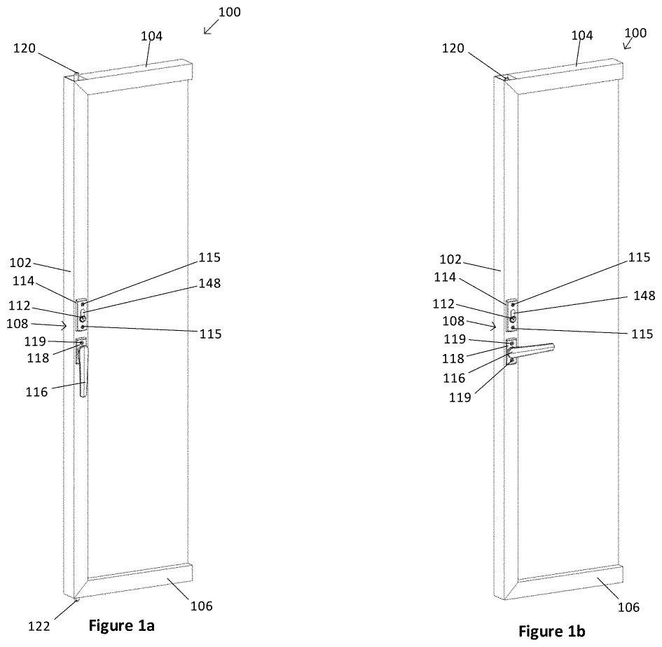

FIG. 1a shows a perspective front side view of part a locking panel 100 including the lock assembly (not visible) that will be described in more detail below. The locking panel 100 is part of window or door assembly, including the window frame or door frame (not shown). The locking panel 100 (so called because it includes the lock assembly) may be either a door panel or a window sash. The locking panel may be part of any suitable type of window or door assembly, including by way of example, a French door or window, a bi-fold door or window, a sliding door or window, or a casement door or window. As will be appreciated, where the lock assembly is a vertical bolt lock it may be particularly well suited to doors or windows where the lock stile of the locking panel does not meet the frame, such as a French door or window. In the example embodiment shown in FIG. 1a, the locking panel 100 is a door panel of either a French or bi-fold door.

The locking panel 100 includes a lock stile 102, a top rail 104 and a bottom rail 106. The locking panel 100 may also include a further stile (not shown). The lock stile 102, top rail 104, bottom rail 106 and further stile may be made from any suitable material. In the example embodiment shown in FIG. 1a, they are extruded members, which may be formed of, for example, aluminium or PVC. As will become apparent, extruded members are particularly suited to the lock assembly described below as they include a hollow inside which the lock assembly can be mounted. While not visible in FIG. 1a, the general location of the lock assembly inside the lock stile 102 is indicated by arrow 108.

The locking panel 100 includes a lock cylinder 148 which is connected to the lock assembly. The lock cylinder includes a keyhole 112. For the purposes of this description it is helpful to describe the lock assembly/lock stile as having a front side and a back side, with the front side corresponding to the side with the keyhole (visible in FIG. 1a) and the back side corresponding to the opposite side to the front side. Turning a compatible key in the keyhole 112 operates the lock assembly, locking and unlocking the lock assembly. In some embodiments, the keyhole 112 may be replaced by a thumb turn. A lock cylinder escutcheon 114 is attached to the front side of the lock stile 102, covering part of the lock assembly and with an opening through which the lock cylinder 148 can pass. The lock cylinder escutcheon 114 includes fasteners 115 that attach the lock cylinder escutcheon 114 to the lock stile 102 and/or the lock assembly and/or a further escutcheon on the back side of the lock stile. The fasteners 115 may also attach the lock assembly to the lock stile 102.

The locking panel 100 also includes a handle 116. The handle 116 is operably connected to the actuator of the lock assembly (which will be described in more detail below). The handle 116 includes a handle escutcheon 118 that is attached to the front of the lock stile 102, covering part of the lock assembly. The handle escutcheon 118 includes fasteners 119 that attach the handle escutcheon 118 (and handle) to the lock stile 102 and/or the lock assembly and/or a further handle escutcheon (and handle) on the back side of the lock stile 102. The fasteners 119 may also attach the lock assembly to the lock stile 102.

Also shown in FIG. 1a is the top distal end 120 of a top rod that is located inside the lock stile 102 and connected to the lock assembly. Also shown is a bottom distal end 122 of a bottom rod that is located inside the lock stile 102 and connected to the lock assembly. The top distal end 120 and bottom distal end 122 engage with a top and bottom strike plate respectively (not shown) in the door or window frame (not shown), thereby latching/locking the locking panel 100.

In FIG. 1a, the lock assembly is in a latched position. In the latched position, the top distal end 120 extends beyond the top of the top rail 104 and the bottom distal end 122 extends below the bottom of the bottom rail 106. Extended in this way, the distal ends 120 122 engage with their respective strike plates (not shown) thereby preventing the locking panel 100 from being opened relative to the door or window frame (now shown). In the latched position, the lock assembly may either be in a locked position or unlocked position.

FIG. 1b shows the locking panel 100 of FIG. 1a, except the lock assembly is in an unlatched position. The lock assembly has been moved from a latched position (FIG. 1a) to an unlatched position (FIG. 1b) by a user turning the handle 116. In the example embodiment shown in FIGS. 1a and 1b, the handle 116 is turned approximately 90 degrees from a generally vertical position (as in FIG. 1a) to a generally horizontal position (as in FIG. 1b). By contrast to FIG. 1a, in the unlatched position, the top rod and bottom rod have been moved (by operation of the handle) to retracted positions such that the top distal end 120 no longer extends beyond the top of the top rail 104 and the bottom distal end 122 no longer extends below the bottom of the bottom rail 106. Retracted in this way, the distal ends 120 122 do not engage with their respective strike plates (not shown) thereby allowing the locking panel 100 to be opened relative to the door or window frame (now shown). In the unlatched position, the lock assembly will be in an unlocked position.

### The Lock Assembly—Cradle

Having described operation of a locking panel 100 including a lock assembly in general, it is helpful to now describe the lock assembly in more detail.

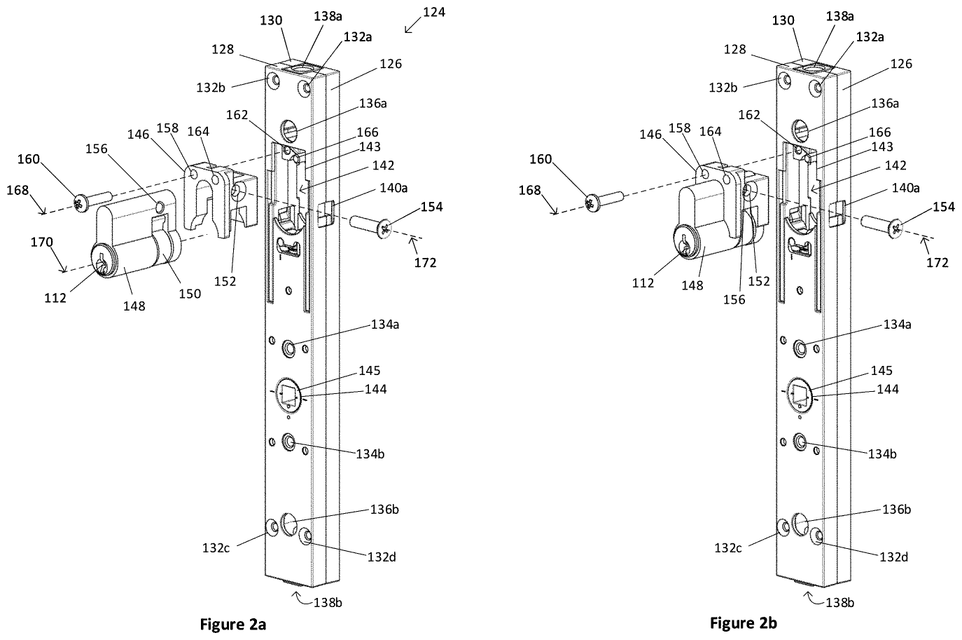

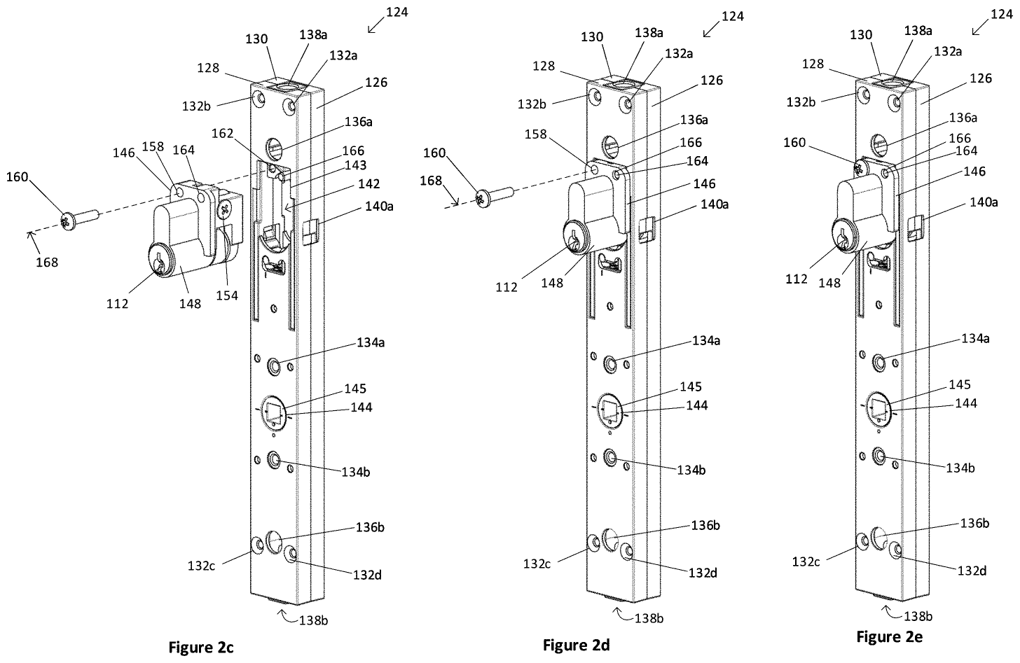

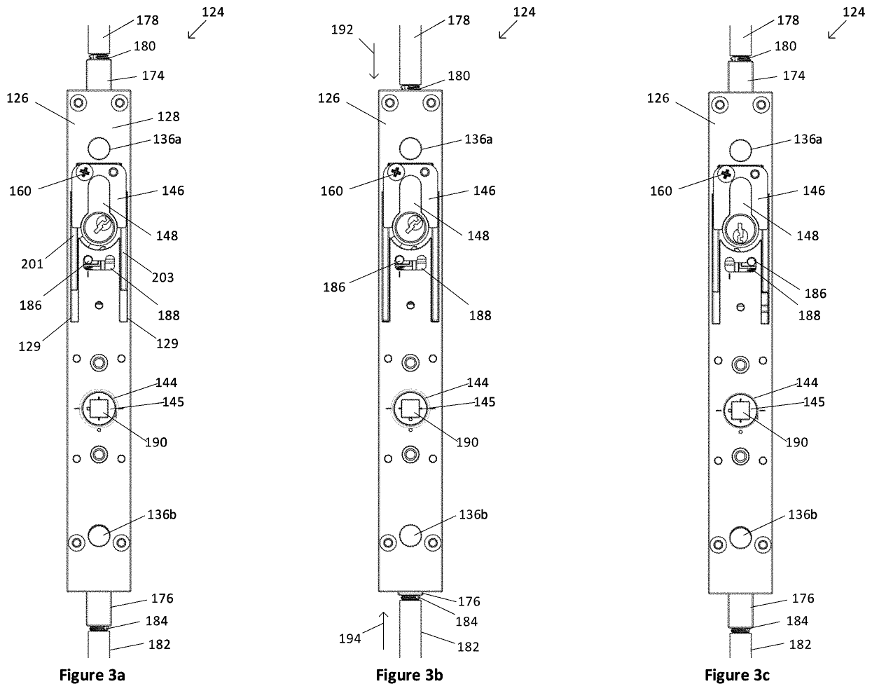

FIG. 2a shows a partially exploded view of part of a lock assembly 124 according to an example embodiment. The lock assembly 124 includes a lock body 126. In the embodiment shown in FIG. 2a, the lock body 126 includes a front casing 128 and back casing 130. The front casing 128 and back casing 130 are connected, thereby securely housing part of the locking mechanism of the lock assembly 124, which will be described in more detail below. For example, the front casing and back casing may be fastened together by suitable fasteners (not shown) through corresponding holes 132a 132b 132c 132d provided in the front casing 128 and back casing 130.

The lock body 126 may include various holes to receive fasteners so that door or window furniture can be attached to the door or window or for other purposes. For example, handle holes 134a 134b correspond to fasteners 119 (described above in relation to FIG. 1a) so that the handle escutcheon 118 can be attached to the lock stile and lock body 126. Apertures 136a 136b pass through the entirety of the lock body 126 so that certain types of front side escutcheons can be attached directly to back side escutcheons. The lock body 126 of FIG. 2a includes a top hole 138a provided on a top face of the lock body 126 and a bottom hole 138b provide on a bottom face of the lock body 126. The top hole 138a and bottom hole 138b provide an opening for the top bolt and bottom bolt (not shown in FIG. 2a) respectively, which will be described in more detail below. The lock body 126 may include side holes on either side face (one of which 140a is visible in FIG. 2a). In the example embodiment shown in FIG. 2a, the side holes are formed by corresponding cut outs in the front casing 128 and back casing 130. The side holes permit rotation of the cam of the lock cylinder. The lock body 126 includes a space 142. The space 142 is generally a void provided inside the lock body 126, that is open to the front side of the front casing 128 by means of an opening 143 in the front casing. The front casing 128 also includes a hole 144 through which the actuator 145 of the lock assembly 124 is accessible. The back casing 130 may include a similar hole, so that the actuator can be operated from both sides.

The lock assembly 124 also includes a cradle 146. The cradle 146 is sized to generally correspond to the space 142 and opening 143, so that the cradle 146 can be inserted, at least partly, through the opening 143 into the space 142. The cradle is also sized to receive and support at least part of a lock cylinder 148. As will be appreciated from FIG. 2a, the cradle 146 includes an ‘internal’ form that complements that form of the lock cylinder 148 and accommodates rotation of the cam 150 of the lock cylinder 148.

The cradle 146 includes a first cradle hole 152 configured to receive a first fastener 154. In the embodiment shown in FIG. 2a, the first fastener 154 is a screw and the first cradle hole 152 is a corresponding screw hole. However, the first fastener may also be another type of fastener, such as a pin or a rivet, and the first cradle hole adapted accordingly. As will be described in more detail below, the first fastener 154 passes through the first cradle hole 152 and a lock cylinder hole 156 provided in the side of the lock cylinder 148, thereby fastening the lock cylinder 148 to the cradle 146. The first cradle hole 152 is sized and positioned so that when the lock cylinder 148 is supported in the cradle 146, the first cradle hole 152 aligns with the lock cylinder hole 156.

The cradle 146 and lock body 126 are configured so that the cradle 146 can be retained, at least partly, inside the space 142. In the embodiment shown in FIG. 2a, the cradle includes a second cradle hole 158 configured to receive a second fastener 160. In the embodiment shown in FIG. 2a, the second fastener 160 is a screw and the second cradle hole 158 is a corresponding screw hole. However, the second fastener may also be another type of fastener, such as a pin or a rivet, with the second cradle hole adapted accordingly. As will be described in more detail below, the second fastener 160 passes through the second cradle hole 158 and a lock body hole 162 provided in the space 142, thereby fastening the cradle 146 to the lock body 126. The second cradle hole 158 is sized and positioned so that when the cradle 146 is inserted in the space 142, the second cradle hole 158 aligns with the lock body hole 162. The axis of the second fastener 160/second cradle hole 158/lock body hole 162 (as indicated by dashed line 168) is substantially parallel to the cylindrical axis of the lock cylinder 148 (as indicated by dashed line 170). The result of this is that the second fastener 160 is installed from the front side of the lock assembly 124.

The cradle 146 may include an alignment hole 164 corresponding to an alignment pin 166 provided inside the space 142. Upon installation, the alignment pin 166 passes through the alignment hole 164, ensuring the cradle is located correctly inside the space 142. Attentively, the alignment pin and alignment hole may be replaced by a further fastener and holes, similar to the second fastener 160 and second cradle hole 158/lock body hole 162.

There may be other means for retaining the cradle 146 inside the space 142, in addition to or instead of the second fastener 160 described above. For example, the cradle 146 and space 142 may be dimensioned so that when the cradle 146 is inserted into the space 142, there is a ‘snug’ fit or a friction fit. The cradle 146 and or the lock body 126 may include complementary clips and/or detents so that insertion of the cradle 146 into the space 142 results in a snap lock fit. Attachment of an escutcheon (for example, the lock cylinder escutcheon 114, described above) may also retain the cradle 146 inside the space 142.

The cradle 146 may be made of any suitable material, including for example, engineering plastic or an engineering metal (such as zinc or aluminium).

Finally, FIG. 2a shows a lock cylinder 148. The lock cylinder 148 of FIG. 2a is a Euro style lock cylinder, which has a standard form. Euro style lock cylinders have several variants including the following: with a keyhole or a thumb turn; full lock size or half lock size; and/or double lock or single lock. The lock cylinder 148 of FIG. 2a is a half lock (which is, by definition, a single lock), with a keyhole 112. It will be appreciated that the lock assembly 124 described herein may be modified for other variants of lock cylinder (whether Euro style or otherwise). One particular standard feature of all variants of Euro style lock cylinder is the lock cylinder hole 156, which is provided on the side of the lock cylinder 148. As outlined in the introduction, this can require, when fastening a lock cylinder to a lock assembly, providing an undesirable opening in the side of the lock style. Because the lock cylinder hole 156 is on the side, the axis of the first fastener 154/first cradle hole 152 (as indicated by dashed line 172) is substantially perpendicular to the cylindrical axis (as indicated by dashed line 170) of the lock cylinder 148.

### Installation of Lock Cylinder, Cradle and Lock Body

Referring to FIGS. 2a to 2e, installation of the lock cylinder will now be described, with reference to the locking panel 100 of FIG. 1a where the lock stile 102 is an extruded member in a door.

Initially, a lock stile opening is formed in the front side of the lock stile 102. The opening is sized and located to correspond to the opening 143 of the front casing 128 for the intended location of the lock assembly 124 inside the lock stile 102. Other openings may be formed on the front side or back side of the lock stile 102 as needed (for example, an opening on the front side and/or back side of the lock stile 102 sized and located to correspond to the actuator 145).

Rods of appropriate length may be attached to the bolts of the lock assembly 124. For the sake of simplicity, the bolts and rods are not shown in FIGS. 2a to 2e. The lock body 126 (including rods) is then inserted into the lock stile 102 and moved to the appropriate vertical position (i.e. so that the opening 143 in the lock body 126 aligns with the opening formed in the lock stile 102 in the previous step). As will be appreciated, since the lock stile 102 is extruded, the lock body 126 can be inserted through the top or bottom. The lock body 126 may be held at the right height by virtue of the rods. Spacers may be inserted between the front side of the lock body 126 and the front side of the lock stile 102, and between the back side of the lock body 126 and the back side of the lock stile 102. The spacers ensure the lock body 126 is located at the appropriate distance between the front side and back side of the lock stile 102. Alternatively, or in addition, the extrusion of the lock stile 102 may have suitable protrusions to ensure correct alignment of the lock body 126 inside the lock stile 102.

Referring to FIG. 2b, the lock cylinder 148 is inserted into the cradle 146 so that the first cradle hole 152 aligns with the lock cylinder hole 156.

Referring to FIG. 2c, the first fastener 154 is inserted through the first cradle hole 152 and the lock cylinder hole 156, thereby fastening the lock cylinder 148 to the cradle 146. In the embodiment of FIGS. 2a to 2e, the first fastener 154 is a screw, so the first fastener is screwed in. Since the lock cylinder 148 has not yet been inserted into the lock body 126 and/or lock stile 102 (i.e. the lock cylinder 148 and cradle 146 are separate from the lock body 126 and lock stile 102 at this stage), the first fastener 154 can be inserted without having to form an opening in the side of the lock stile.

It will be appreciated that the steps described above in relation to FIGS. 2b and 2c may occur before the lock body 126 is inserted into the lock stile and/or the openings are formed in the lock stile 102.

Referring to FIG. 2d, the lock cylinder 148 and cradle 146, is inserted through the opening in the lock stile 102 and through the opening 143 in the lock body 126 into the space 142. Due to the complementary dimensions of the space 142 and cradle 146, the cradle 146 is located in the correct location inside the space 142. When inserting the lock cylinder 148 and cradle 146, the alignment pin 166 is aligned with and inserted into the alignment hole 164. This also ensures the cradle is located in the correction location inside the space 142. As will readily be appreciated from FIG. 2d, part of the cradle 146 remains outside the lock body 126 and the lock cylinder 148 extends away from the front side of the lock body 126 so that the keyhole 112 will be near the surface of the lock stile 102.

Referring to FIG. 2e, the second fastener 160 is inserted through the second cradle hole 158 and the lock body hole 162, thereby fastening the cradle 146 to the lock body 126. In the embodiment of FIGS. 2a to 2e, the second fastener 160 is a screw, so the second fastener is screwed in. In embodiments with other means for retaining the cradle 146 inside the space 142 (for example, providing complementary clips/detents on the cradle and lock body), the cradle 146 may simply need to be inserted into the space 142 until a friction fit or snap lock fit is achieved. The steps described in relation to FIG. 2e can be carried out by an installer from the front side.

Following installation of the lock body 126 inside the lock stile 102, as outlined above, installation of the lock assembly may be completed by attaching suitable door or window furniture to the lock stile 102. For example, the lock cylinder escutcheon 114 may be attached around the lock cylinder 148, obscuring the cradle 146 and the lock body 126 from view, providing a streamlined finish. The handle escutcheon 118 may be attached to the front side of the lock stile 102 such that the handle 116 is connected to the actuator 145 via a suitable drive bar. Following installation, the first fastener 154 is not visible.

While the cradle 146 has been described in relation to a vertical bolt lock assembly (the operation of which will be described below), the cradle 146 may also be used with other types of lock assemblies, with the necessary modifications to its shape and dimensions to suit other lock assemblies.

### Lock Assembly—Locking and Unlocking

Having described the cradle 146 and its installation, the locking and unlocking of the lock assembly 124 will be now be described.

FIG. 3a shows a front side view of the installed lock assembly 124 of FIG. 2e, except with the bolts now shown. There are two bolts shown in FIG. 3a, a top bolt 174 and a bottom bolt 176. The top bolt 174 extends through the top hole (not shown in FIG. 3a) above the lock body 126. The top bolt 174 is connected to a top rod 178 by a suitable connection, which in the embodiment of FIG. 3a is a top threaded connection 180. The top rod 178 extends away from the lock body until the top distal end (described in relation to FIGS. 1a and 1b, but not shown here). While the top bolt 174 and top rod 178 are separate parts (which can ease installation, as the top rod 178 can be more easily cut to size and connected during installation), in some embodiments the top bolt 174 and top rod 178 may be formed as a single part. The bottom bolt 176 extends through the bottom hole (not shown in FIG. 3a) below the lock body 126. The bottom bolt 176 is connected to a bottom rod 182 by a suitable connection, which in the embodiment of FIG. 3a is a bottom threaded connection 184. The bottom rod 182 extends away from the lock body until the bottom distal end (described in relation to FIGS. 1a and 1b, but not shown here). While the bottom bolt 176 and bottom rod 182 are separate parts (which can ease installation, as the bottom rod 182 can be more easily cut to size and connected during installation), in some embodiments the bottom bolt 176 and bottom rod 182 may be formed as a single part.

In FIG. 3a, the lock assembly 124 is in a latched position and an unlocked position. The lock assembly 124 is latched because the top bolt 174 and top rod 178 are extended above the lock body 126 such that the top distal end (not shown) engages with a top strike plate (not shown). The lock assembly 124 is also latched because the bottom bolt 176 and bottom rod 182 are extended below the lock body 126 such that the bottom distal end (not shown) engages with a bottom strike plate (not shown). In this figure, the location of a protrusion 186 inside a protrusion opening 188 indicates that the lock assembly is not in a locked position. As will be described in more detail below, the protrusion 186 holds the lock assembly 124 in a locked position. Once installed, the protrusion 186 may not be visible to a user. In some embodiments, the protrusion 186 may be visible (but not physically accessible) to a user (for example, by providing a clear viewing portal) to provide a visual indication as to whether the lock assembly 124 has been locked or unlocked.

In FIG. 3b, the lock assembly 124 is in an unlatched position and an unlocked position. The protrusion 186 has not moved, indicating that the lock assembly 124 is still unlocked. A user may change from the latched position (FIG. 3a) and the unlatched position (FIG. 3b) by operating a handle (not shown) connected to the actuator 145, which in turn moves the bolts 174 176. The handle may be connected to the actuator, for example, by a drive bar (not shown) inserted into a drive bar opening 190. The drive bar opening 190 has a square profile to prevent rotation of the drive bar in the drive bar opening 190. It will be appreciated from a comparison of FIGS. 3a and 3b, that the actuator 145 has rotated counter clockwise 90 degrees (corresponding to similar rotation of the handle by the user, as shown in FIGS. 1a and 1b). By comparison with FIG. 3a, the lock assembly 124 is now unlatched because the top bolt 174 and top rod 178 are retracted downwards (as indicated by arrow 192) such that the top distal end (not shown) would not engage with a top strike plate (not shown). The lock assembly 124 is also unlatched because the bottom bolt 176 and bottom rod 182 are retracted (as indicated by arrow 194) such that the bottom distal end (not shown) would not engage with a bottom strike plate (not shown). A user can operate the lock assembly moving it between the latched position (FIG. 3a) and the unlatched position (FIG. 3b).

In FIG. 3c, the lock assembly 124 is in a latched position and a locked position. The protrusion 186 has now moved (relative to the position of FIG. 3a), indicating that the lock assembly 124 is locked. A user may change from the unlocked position (FIG. 3a) and the locked position (FIG. 3b) by operating the lock cylinder 148 (which in the embodiment of FIGS. 3a-c, relies on a key, though in some embodiments a thumb turn may be used). As will be described in more detail below, in the locked position the bolts 174 176 are prevented from moving from the extended position, thereby preventing the lock assembly 124 from changing from the latched position, effectively locking the lock assembly. A user can operate the lock assembly moving it between the unlocked position (FIG. 3a) and the locked position (FIG. 3c). Since the lock assembly 124 needs to be in a latched position to be locked, it is not possible to move directly from the unlatched position (FIG. 3b) to the locked position (FIG. 3c) without first latching the lock assembly (FIG. 3a). This behaviour ensures that a user cannot inadvertently ‘lock’ the lock assembly 124 while it is in the unlatched position.

### Lock Assembly—Locking Mechanism

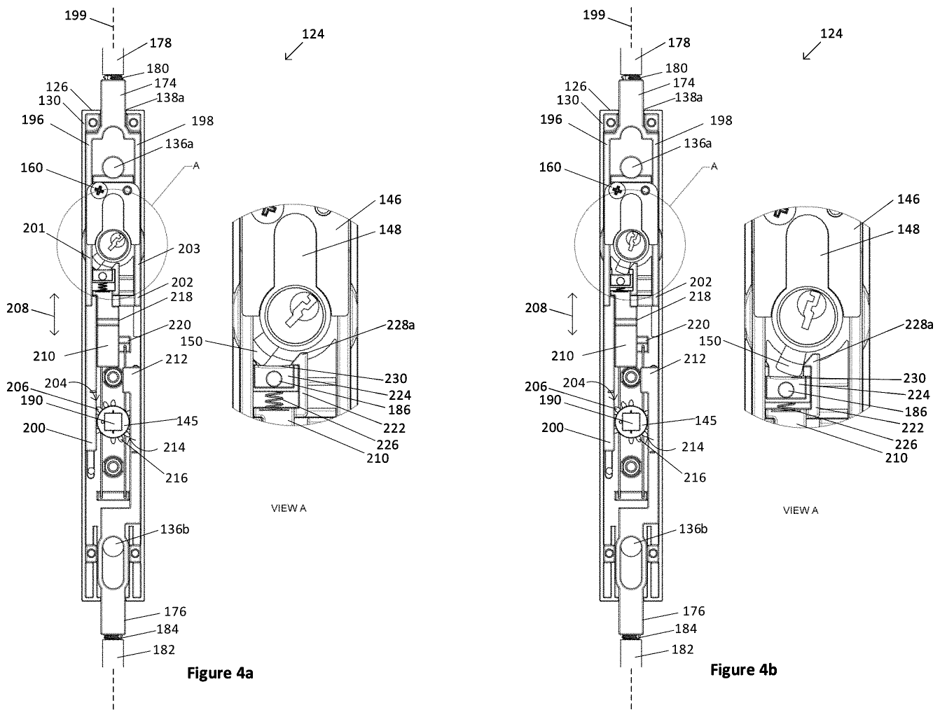

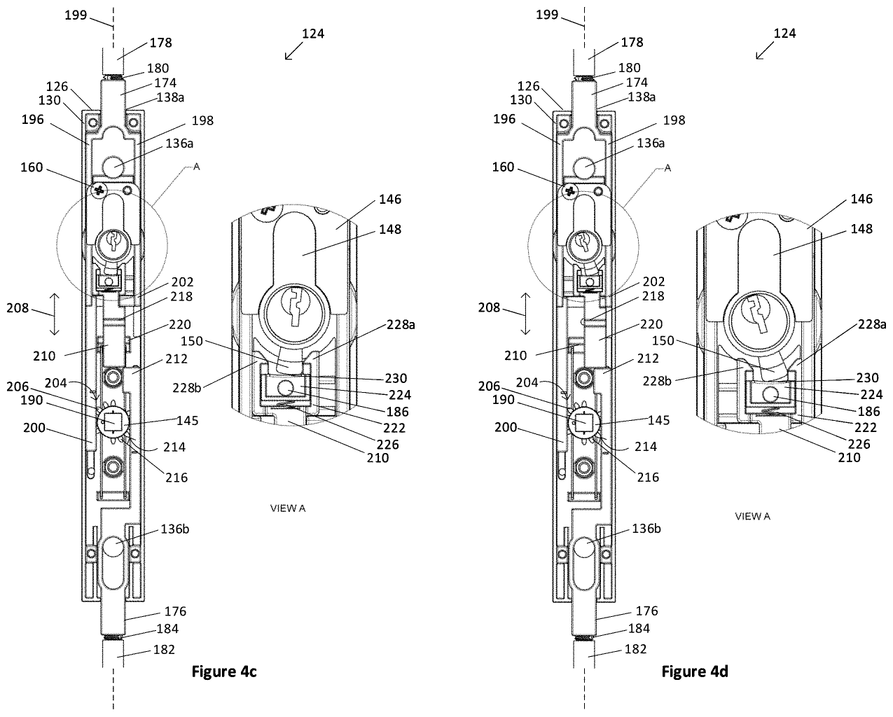

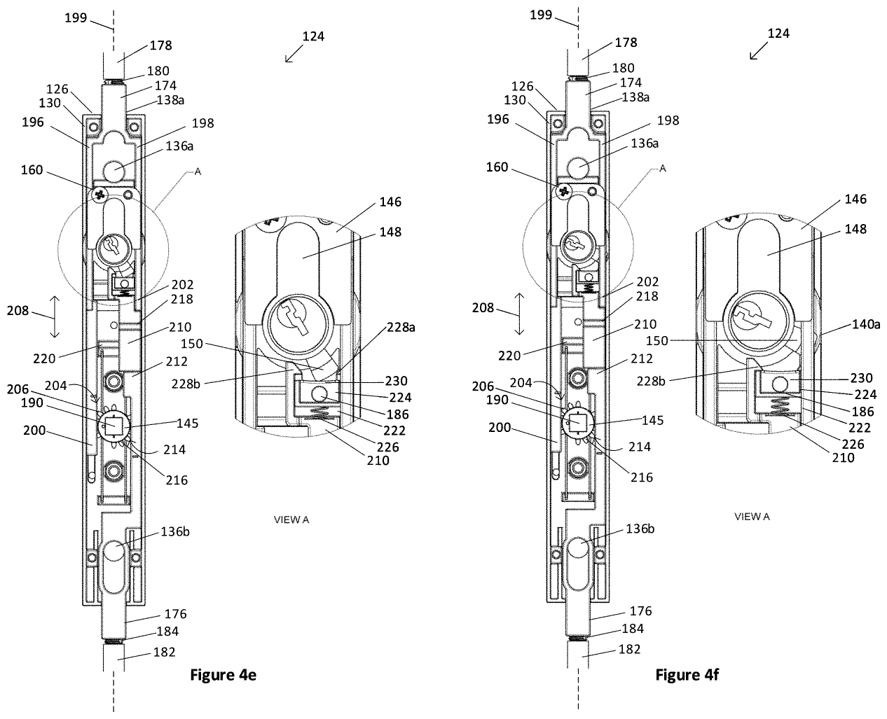

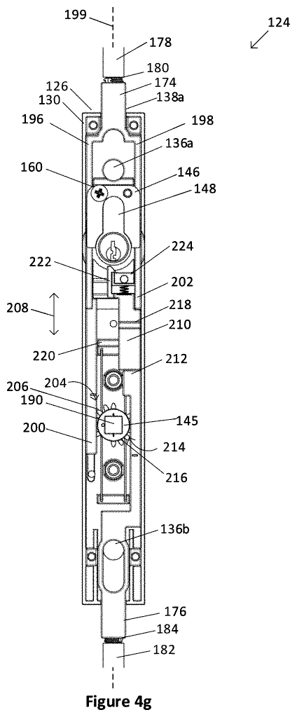

FIG. 4a shows the lock assembly 124 of FIG. 3a with the front casing removed so that the back casing 130 and the inside of the lock body 126 is visible and with circle A being shown in greater detail.

The top bolt 174 is located substantially inside the lock body 126. As previously described, a top end of the top bolt 174 extends through the top hole 138a. Inside the lock body 126, the top bolt 174 divides into two arms, a left arm 196 and a right arm 198. The top bolt divides in this way to bypass the aperture 136a and the cradle 146 and lock cylinder 148. The lower end 200 of the left arm 196 includes a rack (general location indicated by arrow 204). The actuator 145 includes a first set of teeth 206 that engage with the rack 204 such that rotation of the actuator causes the top bolt 174 to move up and down in a linear manner (as indicated by arrow 208) between the extended/latched position and the retracted/unlatched position. The top bolt 174 moves substantially parallel to the longitudinal axis of the lock body (indicated by dashed line 199). As will be described below, the lower end 202 of the right arm interacts with the locking bar 210. While the top bolt 174 is located so as to be substantially centred between the front side and back side of the lock body 126, each arm 196 198 may include bypass portions 201 203 which are located closer to the front side so as to bypass the circular path of the cam 150. Without such bypass portions 201 203, there would need to be room in the lock body 126 either side of the circular path of the cam 150 to accommodate each arm 196 198, making the lock body 126 wider. Such bypass portions enable the widest dimension of the lock body 126 to be determined by the circular path of the cam 150, which may be beneficial in some ‘slimline’ door or windows. As shown, for example in FIG. 3a, the front casing 128 may also include corresponding cut outs 129 to accommodate the bypass portions 201 203.

The bottom bolt 176 is located substantially inside the lock body 126. As previously described, a bottom end of the bottom bolt 176 extends through the bottom hole 138b. Inside the lock body 126, the bottom bolt 176 bypasses the aperture 136b before terminating in an upper end 212 that is substantially aligned vertically with the lower end 202 of the right arm. The upper end 212 includes a rack (general location indicated by arrow 214). The actuator 145 includes a second set of teeth 216 that engage with the rack 214 such that rotation of the actuator causes the bottom bolt 176 to move up and down in a linear manner (as indicated by arrow 208) between the extended/latched position and the retracted/unlatched position. The bottom bolt 176 moves substantially parallel to the longitudinal axis of the lock body (indicated by dashed line 199). As will be described below, the upper end 212 interacts with the locking bar 210.

The relative locations of the bolts 174 176 (and particularly their respective racks 204 214) with respect to the actuator 145 is such that movement of the actuator causes the bolts 174 176 to move in opposite directions. For example, if the actuator 145 is rotated counter clockwise, the top bolt 174 will move downwards until it reaches the retracted position, while the bottom bolt 176 will move upwards until it reaches the retracted position. If the actuator 145 is then rotated clockwise, the top bolt 174 will move upwards until it reaches the extended position, while the bottom bolt 176 will move downwards until it reaches the retracted position. Thus the actuator 145 is able to move both bolts 174 176 simultaneously, but in opposite directions. In the embodiment shown in FIG. 4a, the actuator includes two sets of teeth 206 216, however it may be possible to implement the actuator as a full gear.

Finally, FIG. 4a also shows the locking mechanism. The locking mechanism includes a locking bar 210. As will be described in more detail below, the locking bar 210 slides between the bolts 174 176 to prevent mutual movement of the bolts, thereby locking the lock assembly 124. The locking bar 210 includes recesses that engage with corresponding rails provided on the lock body that ensure the locking bar slides horizontally relative to the lock body 126. In FIG. 4a, a front recess 218 is visible, which would cooperate with a rail (not shown) provided on the front casing and similarly a back rail 220 is visible, which would cooperate with a recess (not shown) provided on the back side of the locking bar 210.

The locking bar 210 includes a cam follower housing 222. The cam follower housing 222 is formed as part of the locking bar 210, however in some embodiments it may be a separate part that is suitably connected to the locking bar 210. The cam follower housing 222 houses a cam follower 224, which is connected to the locking bar 210 via a spring 226. The spring 226 biases the cam follower 224 upwards towards the lock cylinder 148. The cam follower housing 222 includes lips (one of which 228a is visible in FIG. 4a) that prevents the cam follower 224 from being pushed completely out of the cam follower housing 222. The cam follower 224 includes a protrusion 186 which protrudes into a protrusion opening 188. (as previously described). The protrusion opening 188 is shaped to correspond to the path followed by the cam follower 224 as it moves between the locked position and the unlocked position. Each end of the protrusion opening is offset forming a U shape, such that interaction of the protrusion 186 with the protrusion opening 188 prevents the locking bar 210 from being ‘jiggled’ across and out of the locked position. Effectively, the protrusion 186 and protrusion opening 188 holds the cam follower 224 and locking bar 210 in the locked position unless moved by the cam 150. The cam follower 224 includes a curved top surface 230. The locking bar 210 is located inside the lock body 126 so that the top surface 230 engages with the cam 150 of the lock cylinder 148.

### Lock Assembly—Locking Mechanism—Operation

Having described the locking mechanism, its operation will be described with reference to FIGS. 4a to 4g. Starting with FIG. 4a, the lock assembly 124 is in a latched position (the bolts 174 176 being extended) and an unlocked position. In the unlocked position, the locking bar 210 is towards the left such that it does not engage with either the top bolt 174 or bottom bolt 176. A user, using a compatible key (or, alternatively a thumb turn) begins locking the lock assembly 124 by turning the key (in this embodiment, counter clockwise). This causes the cam 150 to follow a circular path until, at the point of FIG. 4a, the cam meets the top surface 230 of the cam follower 224.

The user continues to rotate the key (and therefore the cam 150), which first causes the cam follower 224 to move downwards (as shown in FIG. 4b) and then the cam follower housing 222 to move across (as shown in FIG. 4c). As the cam follower housing 222 moves across the locking bar 210 also moves across. At the point shown in FIG. 4c, it becomes apparent why the lock assembly 124 must be in the latched position to enable locking. If the lock assembly 124 were in the unlatched position, the upper end 212 of the bottom bolt 176 would impede further movement of the locking bar 210. However, since the lock assembly 124 is in the latched position, further rotation of the key (and cam 150) causes the locking bar 210 to slide above the upper end 212 of the bottom bolt 176 (as shown in FIG. 4d) until the locking bar 210 is located between the upper end 212 of the bottom bolt 176 and the lower end 202 of the right arm 198 (as shown in FIG. 4e). At this point, the lock assembly 124 is in the locked position. The key (and cam 150) continue to rotate which causes the cam follower 224 to move upwards under the top surface 230 until it no longer engages with the cam 150 (as shown in FIG. 4f). At the point the key may optionally continue to be rotated until the keyhole is vertical enabling the key to be removed (as shown in FIG. 4g). As will be appreciated from FIG. 4f the side hole 140a (briefly introduced in relation to FIG. 2a permits continued rotation of the cam 150.

In the locked position (for example, FIG. 4e, 4f or 4g), the locking bar 210 is located between the top bolt 174 and bottom bolt 176. The locking bar 210 prevents mutual movement of both bolts away from the latched/extended position, thereby locking the lock assembly 124. Even if the actuator 145 is compromised (for example, by application of excess force to the handle severing one or both sets of teeth 206 216), the bolts 174 176 will remain latched.

To unlock the lock assembly 124, it will be appreciated that the above process can be carried out in reverse.

### Lock Assembly—Variants

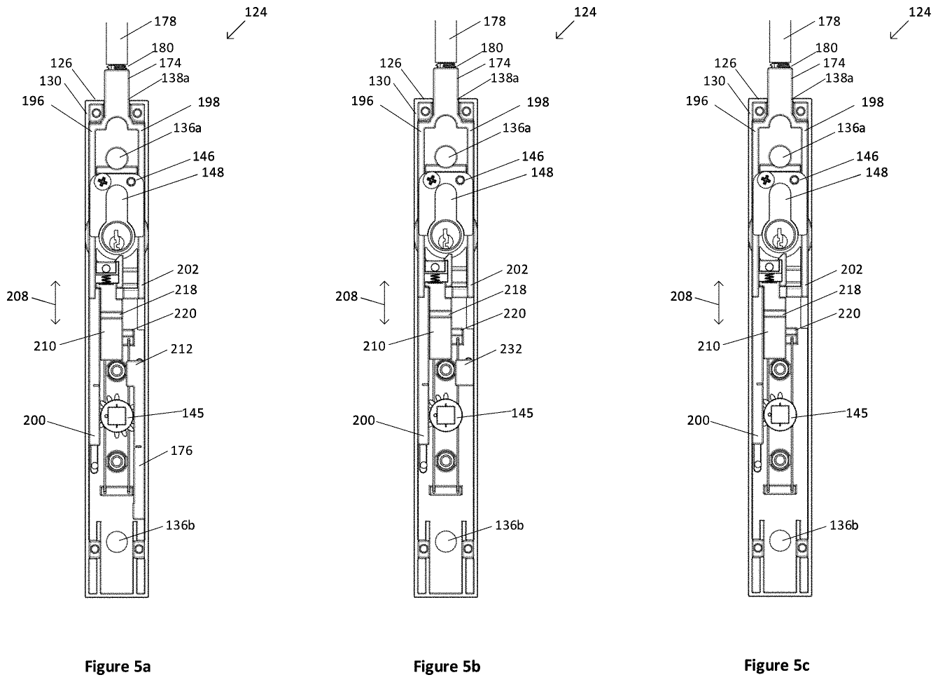

While the above lock assembly has been described in relation to a so-called dual bolt lock assembly, it may be possible to implement a different arrange of bolts. FIGS. 5a to 5c show some possible variants of the above lock assembly 124. In all the variants, the lock assembly 124 are shown in the latched position and unlocked position.

In the embodiment shown in FIG. 5a, while there are two bolts, a top bolt 174 and a bottom bolt 176, only the top bolt 174 extends out of the lock body 126. The bottom bolt 176 has been made shorter so that it is located completely inside the lock body 126 and the bottom hole 138b has been removed. In this embodiment, there is only one latching bolt (the top bolt 174), which may be desirable for certain windows or doors not requiring a dual latching mechanism. Movement of the actuator 145 still causes both bolts 174 176 to move and locking is still achieved by moving the locking bar 210 between the top bolt 174 and bottom bolt 176 to prevent mutual movement of the bolts.

In the embodiment shown in FIG. 5b, the bottom bolt has been replaced by an abutment 232 provided on the inside of the lock body 126 (for example, it may be formed integrally with the back casing 130). Again, this embodiment may be desirable where only one latching bolt is required. Movement of the actuator 145 causes only the top bolt 174 to move. Locking is now achieved by moving the locking bar 210 between the top bolt 174 and abutment 232, thereby preventing movement of the top bolt 174 out of the latched position.

In the embodiment shown in FIG. 5c, the abutment 232 has been removed altogether. This embodiment may be desirable where only one latching bolt is required. Movement of the actuator 145 causes only the top bolt 174 to move. Locking is now achieved by moving the locking bar 210 under the top bolt 174, with the interaction between the top bolt 174, locking bar 210 and rails (the back rail 220 being visible in FIG. 5c) preventing movement of the top bolt 174 out of the latched position.

It will be appreciated that for each of the embodiments described in relation to FIGS. 5a to 5c, it may be possible to retain the bottom bolt and vary the top bolt.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A lock assembly comprising:
a cradle configured to support at least part of a lock cylinder;
a lock body configured to retain the cradle at least partly inside a space provided in the lock body; and
a first fastener for fastening the lock cylinder to the cradle.

2. The lock assembly as claimed in claim 1, wherein the cradle comprises a first cradle hole adapted to receive the first fastener.

3. The lock assembly as claimed in claim 2, wherein the first cradle hole is substantially perpendicular to a cylindrical axis of the lock cylinder when installed.

4. The lock assembly as claimed in claim 2, wherein the first cradle hole is positioned so that when the cradle supports at least part of the lock cylinder, the first cradle hole aligns with a lock cylinder hole provided in the lock cylinder such that the first fastener can pass through both the first cradle hole and the lock cylinder hole to fasten the lock cylinder to the cradle.

5. The lock assembly as claimed in claim 1, wherein the cradle comprises a second cradle hole configured to receive a second fastener, the second fastener for fastening the cradle to the lock body.

6. The lock assembly as claimed in claim 5, wherein the second cradle hole is substantially parallel to a cylindrical axis of the lock cylinder when installed.

7. A cradle configured for the lock assembly of claim 1.

8. A method for installing a lock assembly in a door or window comprising:
attaching a lock cylinder to a cradle using a first fastener; and
attaching the cradle to a lock body.

9. The method as claimed in claim 8, wherein attaching the lock cylinder to the cradle precedes attaching the cradle to the lock body.

10. The method as claimed in claim 8, wherein attaching the cradle to the lock body comprises attaching the cradle to the lock body using a second fastener.

11. The method as claimed in claim 8, further comprising:
inserting at least part of the cradle into a space provided inside the lock body.

12. The method as claimed in claim 11, further comprising:
forming an opening in an extruded member of the window or door, the opening located to correspond to an intended location of the space; and
inserting the lock body inside the extruded member such that the space meets the opening.

13. The method as claimed in claim 8, wherein the lock assembly comprises:
a cradle configured to support at least part of a lock cylinder;
a lock body configured to retain the cradle at least partly inside a space provided in the lock body; and
a first fastener for fastening the lock cylinder to the cradle.

14. A lock assembly comprising:
a lock body having a longitudinal axis;
a first bolt provided at least in part inside the lock body and configured to move substantially parallel to the longitudinal axis and between a first retracted position and a first extended position;
an actuator configured to move the first bolt between the first retracted position and the first extended position; and
a locking bar configured in an unlocked position to allow the first bolt to move to or from the first extended position and in a locked position to engage with the first bolt preventing the first bolt from moving from the first extended position.

15. The lock assembly of claim 14, wherein the locking bar comprises a cam follower housing, the cam follower housing comprising a cam follower that has a surface which engages with an end of a cam provided in a lock cylinder such that rotation of the cam causes the cam follower and the locking bar to move.

16. The lock assembly of claim 14, wherein the first bolt is configured to be connected to a first rod, the first rod extending away from the lock body such that a first rod distal end of the first rod is able to engage with a first strike plate provided in a frame of a window or door.

17. The lock assembly of claim 14, comprising a second bolt provided at least in part inside the lock body and configured to move substantially parallel to the longitudinal axis and between a second retracted position and a second extended position, wherein:
the actuator is configured to move the second bolt between the second retracted position and the second extended position; and
the locking bar is configured in the unlocked position to allow the first bolt to move to or from the first extended position or the second bolt to move to or from the second extended position.

18. The lock assembly of claim 17, wherein the locking bar is configured in a locked position to engage with the second bolt preventing the second bolt from moving from the second extended position, and the locking bar is configured so that the locking bar can only move from the unlocked position to the locked position provided the first bolt is in the first extended position and/or the second bolt is in the second extended position.

19. The lock assembly of claim 17, wherein the first bolt and second bolt move in opposite directions, and the actuator is configured to move both the first bolt and second bolt simultaneously.

20. The lock assembly of claim 17, wherein the second bolt is configured to be connected to a second rod, the second rod extending away from the lock body such that a second rod distal end of the second rod is able to engage with a second strike plate provided in a frame, and the second rod extends to the opposite side of the lock body than a first rod.
